(19) United States
(12) Patent Application Publication
(10) Pub. No.: US 2020/0329916 A1
(43) Pub. Date: Oct. 22, 2020

(54) NUT CRACKER

(71) Applicant: SHENZHEN LANHAIXING TECHNOLOGY CO., LTD., Shenzhen (CN)

(72) Inventor: Xiaoguang LI, Shenzhen (CN)

(73) Assignee: SHENZHEN LANHAIXING TECHNOLOGY CO., LTD., Shenzhen (CN)

(21) Appl. No.: 16/068,895

(22) PCT Filed: Dec. 27, 2017
(86) PCT No.: PCT/CN2017/119016

§ 371 Date: Jul. 10, 2018

(30) Foreign Application Priority Data
Jul. 26, 2017 (CN) 2017209130601

(51) Int. Cl. A47J 43/26

(52) U.S. Cl. CPC A47J 43/26

(57) ABSTRACT

A nut cracker includes a main member with a first handle portion extending therefrom, a gear cutter member including a gear cutter, a clamping member including a clamping bar connected to the first handle portion to cooperatively form a handle, and a stopping switch member connected to the main member. The clamping bar can drive the gear cutter move when the handle can move back and forth between a first state and a second state under an external force. In the first state, a distance between the first handle portion and the clamping bar is minimum, with the clamping bar meshed with the gear cutter. In the second state, a distance between the first handle portion and the clamping bar is maximum, with the clamping bar meshed with the stopping switch member to prevent the gear cutter from backing off to avoid crushing flesh of nuts due to excessive force.

### BACKGROUND

### 1. Technical Field

The present disclosure generally relates to daily living utensils field, and especially relates to a nut cracker.

### 2. Description of Related Art

Nuts are a king of fruit of closed fruits, which have hard shell and contain one or more seeds therein, such as chestnuts, almonds, etc. Nuts are a quintessential part of a plant and generally nutritious which include high protein, grease, mineral and vitamin, thereby they are an excellent effect on human growth, development, physical constitution and disease prevention. As a result of the above functional effects, people are very fond of nuts. However, nuts have hard shells, especially macadamia nuts, which are hard to crack and inconvenient to eat. A conventional nut cracker can easily crush flesh of the nut during opening the nut, thereby resulting in inconvenient to use.

### SUMMARY

The technical problems to be solved: in view of the shortcomings of the related art, the present disclosure relates to a nut cracker which can prevent a gear cutter frown backing off during use of the nut cracker so that the gear cutter can apply a litter force on a nut to open it, thereby avoiding a problem of crushing of flesh of the nut due to excessive force.

The technical solution adopted for solving technical problems of the present disclosure is:
A nut cracker includes a main member including a first portion and a second portion, with a first handle portion extending downward from the second portion of the main member; a gear cutter member including a gear cutter rotatably connected to the first portion of the main member; a clamping member including a clamping bar rotatably connected to the second portion of the main member; a stopping switch member rotatably connected to the second portion of the main member; and a handle formed by the first handle portion together with the clamping bar. The clamping bar can drive the gear cutter move when the handle moves back and forth between a first state and a second state by an external force; in the first state, a distance between the first handle portion and the clamping bar is minimum and the clamping bar is meshed with the gear cutter, while in the second state, a distance between the first handle portion and the clamping bar is maximum and the clamping bar is meshed with the stopping switch member to prevent the gear cutter from backing off.

A nut cracker according to an exemplary embodiment of the present disclosure includes a main member including a first portion and a second portion; a gear cutter member including a gear cutter rotatably connected to the first portion of the main member; a clamping member including a clamping bar rotatably connected to the second portion of the main member and meshed with the gear cutter; a stopping switch member rotatably connected to the second portion of the main member and including a stopping switch provided for preventing the gear cutter from backing off, and a first elastic element with one end thereof abutting against the stopping switch for resetting the stopping switch; and a locating structure fixed to the first portion of the main member for fastening a nut.

The present disclosure provides the advantages as below.

The structure of the present disclosure is provided that the clamping bar can drive the gear cutter move when the handle moves back and forth between the first state and the second state under an action of an external force, thereby the stopping switch member can prevent the gear cutter from backing off during use of the nut cracker so that the gear cutter can apply a litter force on a nut to open it, which can avoid a problem of crushing of flesh of the nut due to excessive force.

### BRIEF DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is an assembly schematic view of the nut cracker in accordance with an exemplary embodiment, shown a handle of the nut cracker in a first state.

FIG. 2 is similar to FIG. 1, but shown the handle of the nut cracker in a second state.

FIG. 3 is similar to FIG. 1, but shown a relationship between a gear cutter, a clamping bar and a stopping switch of the nut cracker of FIG. 1 indicated by dotted lines.

FIG. 4 is similar to FIG. 2, but shown a relationship between the gear cutter, the clamping bar and the stopping switch of the nut cracker of FIG. 1 indicated by dotted lines.

FIG. 5 is an exploded, schematic view of the nut cracker of FIG. 1.

FIG. 6 is a partial sectional view of the nut cracker of FIG. 1.

FIG. 7 is a schematic view of a clamping spring of the nut cracker of FIG. 1.

FIG. 8 is a schematic view of the clamping bar of the nut cracker of FIG. 1.

FIG. 9 is a schematic view of a gear cutter spring of the nut cracker of FIG. 1.

FIG. 10 is a schematic view of the gear cutter of the nut cracker of FIG. 1.

FIG. 11 is a schematic view of a main member of the nut cracker of 1.

FIG. 12 is a schematic view of the stopping switch of the nut cracker of FIG. 1.

### DETAILED DESCRIPTION

The disclosure is illustrated by way of example and not by way of limitation in the figures of the accompanying drawings, in which like reference numerals indicate similar elements.

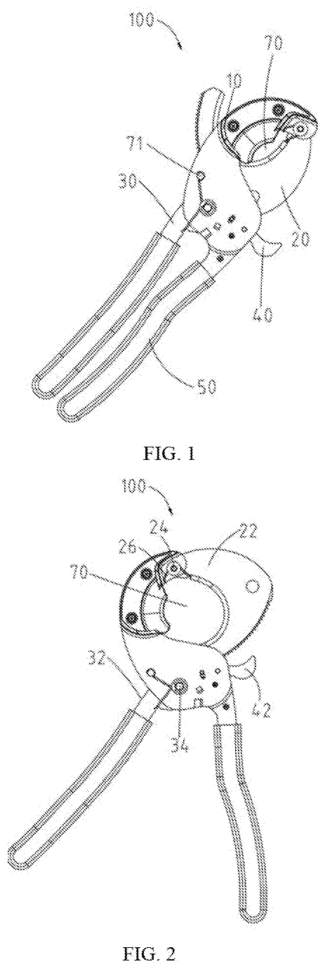

Referring to FIGS. 1-5, the nut cracker 100 in accordance with an exemplary embodiment of the present disclosure includes a main member 10, a gear cutter member 20, a clamping member 30, a stopping switch member 40 and a handle 50. The gear cutter member 20 includes a gear cutter 22 rotatable connected to a first portion of the main member 10. The clamping member 30 includes a clamping bar 32 rotatably connected to a second portion of the main member 10 and the stopping switch member 40 is also connected to the second portion of the main member 10. A first handle portion 52 is extended downward from the second portion of the main member 10 and connected to the clamping bar 32 to cooperatively form the handle 50. The clamping bar 32 can drive the gear cutter 22 move when the handle 50 moves back and forth between a first state and a second state under an external force. In the first state, a distance between the first handle portion 52 and the clamping bar 32 is minimum and the clamping bar 32 is meshed with the gear cutter 22, while in the second state, a distance between the first handle portion 52 and the clamping bar 32 is maximum and the clamping bar 32 is meshed with the stopping switch member 40 to prevent the gear cutter 22 from backing off.

Because the handle 50 can move back and forth between the first state and the second state by the external force so that the stopping switch member 40 can prevent the gear cutter 22 from backing off during use of the nut cracker 100, thereby the gear cutter 22 can apply a litter force on a nut to open it, which can avoid a problem of crushing the nut pulp due to excessive force.

Referring to FIG. 3 and FIG. 8, in an exemplary embodiment of the present disclosure, the clamping bar 32 includes a plurality of first teeth 320 at a head portion thereof and the gear cutter 22 includes a plurality of second teeth 220 at a bottom thereof. In this way, the clamping bar 32 can drive the gear cutter 22 move by the first tooth 320 meshing with a corresponding second tooth 220. At the same time, a moving travel of the gear cutter 22 is proportional to a length of the second tooth 220, that is to say, the movement of the gear cutter 22 is determined by the length of the plurality of second teeth 220. When a last tooth of the plurality of second teeth 220 is meshed with the corresponding first tooth 320, the gear cutter 22 can't further move, thereby preventing the gear cutter 22 from pressing against the nut again and avoiding nut pulp from being crushed by the gear cutter 22.

Referring to FIGS. 1-5, the clamping member 30 further includes a clamping shaft 34 connected to the second portion of the main member 10 for rotatable installing the clamping bar 32 with the second portion, and a clamping spring 36 sleeved on the clamping shaft 34 for resetting the clamping bar 32 and driving the clamping bar 32 mesh with or separate from the gear cutter 22.

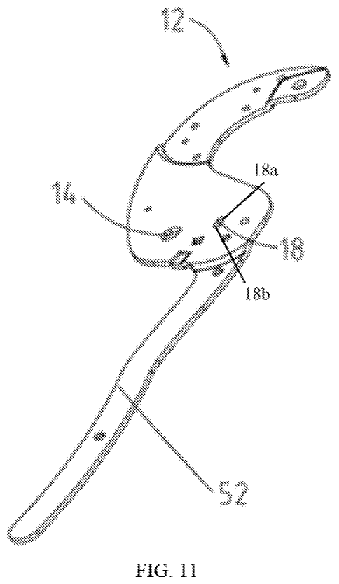

Furthermore, the main member 10 further includes a receiving recess 14 (shown in FIG. 11) formed on the second portion for slidably receiving the clamping shaft 34 therein.

In an exemplary embodiment of the present disclosure, the receiving recess 14 is a waist-shaped configuration, thereby the clamping shaft 34 can slide in the receiving recess 14 so that the clamping bar 32 can mesh with or separate from the gear cutter 22.

In an exemplary embodiment f the present disclosure, resetting of the clamping bar 32 is meant that the clamping bar 32 can move from the first state to the second state under the action of the clamping spring 36. That is, the distance between the clamping bar 32 and the first handle portion 52 is maximum.

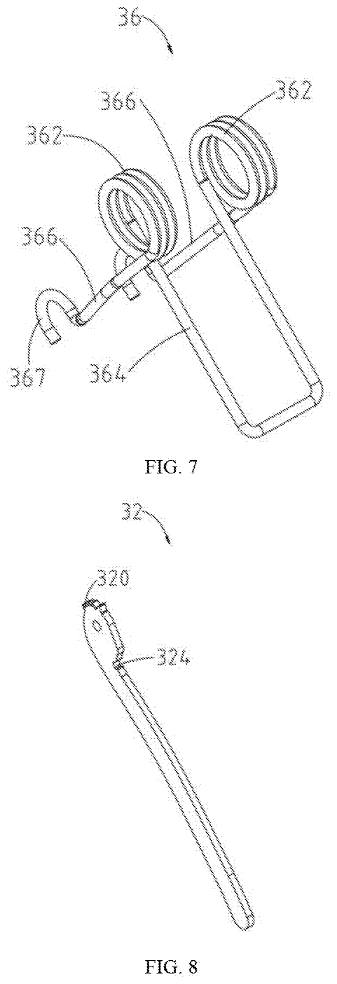

Referring to FIG. 2 and FIG. 7, furthermore, the clamping spring 36 includes a pair of first fixing portions 362 and a second fixing portion 364 formed between the pair of first fixing portions 362. The camping shaft 34 is inserted into the pair of first fixing portions 362 in turn, and d the second fixing portion 364 is fixed to the clamping bar 32.

Referring to FIG. 7 and FIG. 8 the clamping bar 32 includes a first receiving groove 324 close to the plurality of first teeth 320 for partially receiving the second fixing portion 364 therein to reset the clamping bar 32.

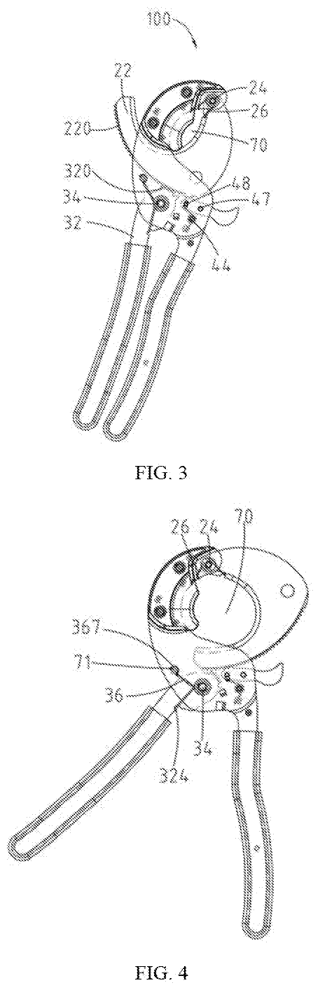

Referring to FIG. 3 and FIG. 4, in the first state, the clamping spring 36 is in its tension state, while in the second state, the clamping spring 36 is in its original state.

In an exemplary embodiment of the present disclosure, the clamping spring 36 is a wire spring. The original state of the clamping spring 36 is a pre-pressed state, that is to say, in the original state, the clamping spring 36 has a certain pre-pressure.

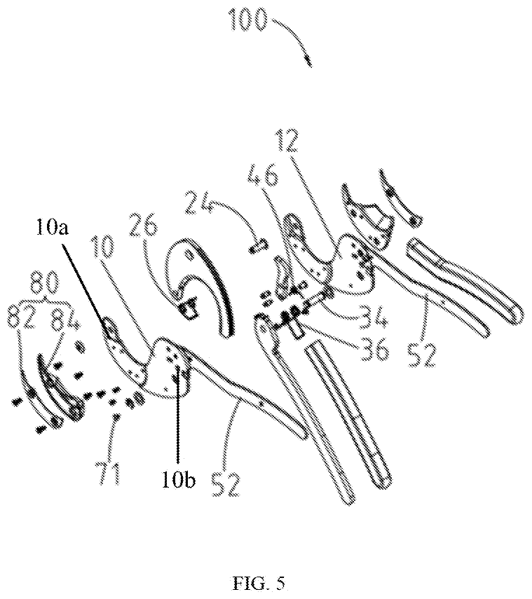

Referring to FIG. 4. FIG. 5 and FIG. 7, furthermore, the clamping spring 36 further includes a pair of first fastening portions 366 and the main member 10 includes a pair of main bodies 12. The pair of first fastening portions 366 is respectively fixed to a corresponding main body 12.

Furthermore, each first fastening portion 366 is extended outward from a distal end of the first fixing portion 362 so that a first fixing bar 367 is formed at a distal end of the first fastening portion 366. The first fixing portion 362 is formed at a distal end of the second fixing portion 364 in a spiral way.

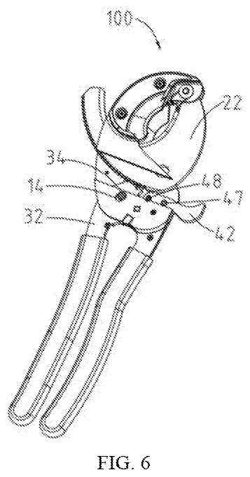

Referring to FIG. 1 and FIG. 6, the nut cracker 100 further includes a pair of first locating posts 71 respectively fixed to a corresponding main body 12 and a corresponding first fixing bar 367.

In an exemplary embodiment of the present disclosure, a pair of triangles is formed by connecting lines of the first locating post 71, the clamping shaft 34 and the first receiving groove 324. The pair of triangles is respectively formed between an outer surface of a corresponding main body 12 and a first receiving groove 324.

Because the triangle is formed by connecting lines of the first locating post 71, the clamping shaft 34 and the first receiving groove 324, thereby the clamping spring 36 can be firmly fixed.

Referring to FIGS. 1-4, the nut cracker 100 further includes a receiving room 70 surrounded by the main member 10 and the gear cutter member 20 for receiving a nut therein. A volume of the receiving room 70 can change to open a shell of the nut when the handle 50 moves back and forth between the first state and the second state.

In an exemplary embodiment of the present disclosure, the volume of the receiving room 70 can be changed according to a size of the nut. So, the nut cracker 100 of the present disclosure can be applied to different nuts. The present disclosure can open all kinds of nuts with only one nut cracker 100 at home, thereby greatly improving the convenience of use.

Furthermore, the minimum volume of the receiving room 70 of the present disclosure is greater than that of a user's finger. That is to say, users can't accidentally injure their fingers when they use the nut cracker 100 of the present disclosure. Moreover, children can't cut their fingers during playing with the nut cracker 100 of the present disclosure.

Referring to FIGS. 1-5, the gear cutter member 20 further includes a gear cutter shaft 24 fixed to the first portion of the main member 10 and a gear cutter spring 26 sleeved on the gear cutter shaft 24 for resetting the gear cutter 22.

In an exemplary embodiment of the present disclosure, when the gear cutter 22 moves to its final position, that is, the volume of the receiving room 70 is minimum, the clamping bar 32 returns to the second state under the action of the clamping spring 36. At this time, the gear cutter 22 is separated from the clamping bar 32. The plurality of second teeth 220 of the gear cutter 22 is separated from the stopping switch 42 no matter how the user exerts force on the handle 50 to move it the first state, that is, the minimum tightening state. When the handle 50 is released, the gear cutter 22 can open again to mesh with the stopping switch 42. Such a repetitive grip does not further feed, thereby avoiding accidental injury to the user. At the same time, the stopping switch 42 is separated from the gear cutter 22 under the action of the external force, and the gear cutter 22 is reset under the action of the gear cutter spring 26, namely the volume of the receiving room 70 is maximum.

When the volume of the receiving room 70 is minimum, the gear cutter spring 26 is compressed, while when the volume of the receiving room 70 is maximum, the gear cutter spring 26 is in its original state.

In an exemplary embodiment of the present disclosure, the gear cutter spring 26 is a wire spring. The original state of the gear cutter spring 26 is a pre-pressed state, that is to say, in the original state, the gear cutter spring 26 has a certain pre-pressure.

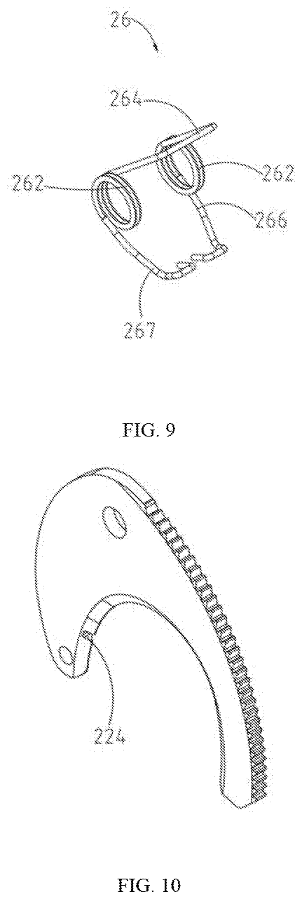

Referring to FIG. 5 and FIG. 9 the gear cutter spring 26 includes a pair of third fixing portions 262 and a fourth fixing portion 264 formed between the pair of third fixing portions 262. The gear cutter shaft 24 is inserted into the pair of third fixing portions 262 in turn, and the fourth fixing portion 264 is fixed to the gear cutter 22.

Furthermore, the gear cutter spring 26 further includes a pair of second fastening portions 266 respectively fixed to a corresponding main body 12 of the main member 10.

Furthermore, each second fastening portion 266 is extended outward from a distal end of the third fixing portion 262 so that a second fixing bar 267 is formed at a distal end of the second fastening portion 266. The third fixing portion 262 is formed at a distal end of the fourth fixing portion 264 in a spiral way. Each second fixing bar 267 can hook a corresponding main body 12.

Referring to FIG. 9 and FIG. 10, the gear cutter 22 includes a second receiving groove 224 away from the plurality of second teeth 220 for partially receiving the fourth fixing portion 264 therein to reset the gear cutter 22.

In an exemplary embodiment of the present disclosure, a triangle is formed by connecting lines of the gear cutter shaft 24, the second receiving groove 224 and the first fixing bar 367, thereby the gear cutter spring 26 can be firmly fixed.

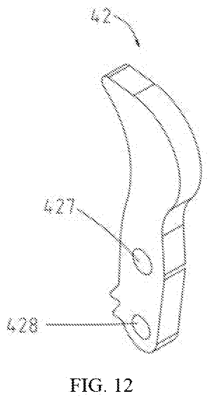

Referring to FIG. 5 and FIG. 12, the stopping switch member 40 includes a stopping switch 42 for preventing the gear cutter 22 from backing off and a first elastic element 46 with one end thereof abutting against the stopping switch 42 for resetting the stopping switch 42.

Referring to FIG. 3, FIG. 4, FIG. 5, FIG. 6 and FIG. 12, furthermore, the stopping switch member 40 further includes a rotating shaft 47 inserted into a first hole 427 of the stopping switch 42 so that the stopping switch 42 can rotate around the center of the rotating shaft 47.

Furthermore, the stopping switch member 40 further includes a fixing post 44 fixed to the second portion of the main member 10 and the first elastic element 46 is sleeved around the fixing post 44.

Furthermore, the stopping switch member 40 further includes a moving post 48 passing through a second hole 428 of the stopping switch 42 to be movably received in a moving recess 18 (seen in FIG. 11) of the main member 10.

Furthermore, in the first state, the gear cutter 22 is separated from the stopping switch 42, the first elastic element 46 is compressed and the moving post 48 is positioned on a second end of the moving recess 18. While in the second state, the first elastic element 46 is in its original state, the moving post 48 is positioned on a first end of the moving recess 18, and the gear cutter 22 is meshed with the stopping switch 42. The stopping switch 42 can prevent the gear cutter 22 from backing off when the handle 50 is moved back and forth between the first state and the second state. So, the nut cracker 100 of the present disclosure can be applied to different nuts.

Referring to FIG. 5, the nut cracker 100 further includes a locating structure 80 fixed to the first portion of the main member 10 for fastening the nut. The locating structure 80 includes a pair of fixing members 82, and a pair of receiving members 84 respectively fixed to a first portion of the main member 10 by a corresponding fixing member 82. A radian of the fixing members 82 is same as that of the first portion of the main member 10 and a radian of a contacting part between the receiving member 84 and the fixing members 82 is also same as that of the fixing members 82.

Referring to FIGS. 1-12, when assembly the nut cracker 100, the locating structure 80 is first fixed to the first portion of the main member 10 so that the gear cutter member 20 is also installed in the first portion of the main member 10. Both the clamping member 30 and the stopping switch member 40 are then respectively fixed to the second portion of the main member 10. At the same time, the gear cutter 22 is meshed with the clamping bar 32 or the stopping switch 42. Thus, the nut cracker 100 assembled by the main member 10, the gear cutter member 20, the clamping member 30 and the stopping switch member 40 is completed.

In use, the handle 50 is driven by an external force to repeatedly move between the first and the second state so that the clamping bar 32 drives the state gear cutter 22 move to press the nut until the nut is cracked. In this position, the stopping switch 42 is separated from the gear cutter 22 by the external force. The gear cutter 22 is also reset under the action of the gear cutter spring 26, that is, the volume of the receiving room 70 is maximum.

In an exemplary embodiment of the present disclosure, the first state of the handle 50 is defined as a closed state, while the second state of the handle 50 is defined as an opening state. That is, the handle 50 can move between the opening state and the closed state.

In the course of use, the movement of the gear cutter 22 of the present disclosure is realized through opening and closing the handle 50, that is, it is achieved the purpose of energy saving through the principle of lever.

In use, the clamping spring 36 not only can reset the clamping bar 32, but also can drive the clamping bar 32 mesh with the gear cutter 22. That is to say, the clamping spring 36 simultaneously has two functions: one function is to reset the clamping bar 32 and drive the handle 50 move between the opening state and the closed state, the other function is to drive the clamping bar 32 mesh with the gear cutter 22 for achieving the purpose of cutting the nut shell.

The nut cracker 100 of the present disclosure is mainly used for crust breaking of macadamia nuts and other nuts, with a diameter of the nut between Φ16-Φ32 mm. Of course, the nut cracker 100 of the present disclosure is also suitable for other types of nuts such as pecans, walnuts, almonds, hazelnuts, chestnuts, etc

In an exemplary embodiment of the present disclosure, the receiving room 70 is a waist-shaped hole similar to the shape of most nuts, which improves the convenience of use.

In an exemplary embodiment of the present disclosure, the cross-section of a working surface of the gear cutter 22 contacting with the nut is designed in a form of a v-shaped cutting knife to facilitate opening the nut shell.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

1. A nut cracker, comprising:
a main member comprising a first portion and, a second portion opposite to the first portion, with a first handle portion extending downward from the second portion of the main member;
a gear cutter member comprising a gear cutter rotatably connected to the first portion of the main member;
a clamping member comprising a clamping bar rotatably connected to the second portion of the main member;
a stopping switch member rotatably connected to the second portion of the main member;
a handle formed by the first handle portion together with the clamping bar; and wherein
the clamping bar can drive the gear cutter move when the handle moves back and forth between a first state and a second state under an external force; in the first state, a distance between the first handle portion and the clamping bar is minimum and the clamping bar is meshed with the gear cutter; while in the second state, a distance between the first handle portion and the clamping bar is maximum and the clamping bar is meshed with the stopping switch member to prevent the gear cutter from backing off.

2. The nut cracker as claimed in claim 1, wherein the clamping member further comprises a clamping shaft connected to the second portion of the main member for rotatably installing the clamping bar with the second portion, and a clamping spring sleeved on the clamping shaft.

3. The nut cracker as claimed in claim 2, wherein the clamping spring is provided for not only resetting the clamping bar and driving the handle move between an opening position and a closing position, but also driving the clamping bar mesh with or separate from the gear cutter.

4. The nut cracker as claimed in claim 1, wherein the nut cracker further comprises a receiving room surrounded by the main member and the gear cutter member for receiving a nut therein, and a volume of the receiving room can be changed to open a shell of the nut when the handle moves back and forth between the first state and the second state.

5. The nut cracker as claimed in claim 1, wherein the gear cutter member further comprises a gear cutter shaft fixed to the first portion of the main member and a gear cutter spring sleeved on the gear cutter shaft for resetting the gear cutter.

6. The nut cracker as claimed in claim 1, wherein the stopping switch member comprises a stopping switch for preventing the gear cutter from backing off and a first elastic element with one end thereof abutting against the stopping switch for resetting the stopping switch.

7. The nut cracker as claimed in claim 6, wherein the stopping switch member further comprises a rotating shaft inserted into a first hole of the stopping switch so that the stopping switch can rotate around the center of the rotating shaft.

8. The nut cracker as claimed in claim 7, wherein the stopping switch member further comprises a fixing post fixed to the second portion of the main member and the first elastic element sleeved around the fixing post.

9. The nut cracker as claimed in claim 8, wherein the stopping switch member further comprises a moving post passing through a second hole of the stopping switch to be movably received in a moving recess of the main member.

10. The nut cracker as claimed in claim 9, wherein in the first state, the gear cutter is separated from the stopping switch, the first elastic element is compressed and the moving post is positioned on a second end of the moving recess, while in the second state, the first elastic element is in an original state, the moving post is positioned on a first end of the moving recess, and the gear cutter meshed with the stopping switch.

11. A nut cracker, comprising:
a main member comprising a first portion and a second portion opposite to the first portion;
a gear cutter member comprising a gear cutter rotatably connected to the first portion of the main member;
a clamping member comprising a clamping bar rotatably connected to the second portion of the main member and meshed with the gear cutter;
a stopping switch member rotatably connected to the second portion of the main member and comprising a stopping switch provided for preventing the gear cutter from backing off, and a first elastic element with one end thereof abutting against the stopping switch for resetting the stopping switch; and
a locating structure fixed to the first portion of the main member for fastening a nut.

12. The nut cracker as claimed in claim 11, wherein the stopping switch member further comprises a rotating shaft inserted into a first hole of the stopping switch so that the stopping switch can rotate around the center of the rotating shaft.

13. The nut cracker as claimed in claim 12, wherein the stopping switch member further comprises a moving post passing through a second hole of the stopping switch to be movably received in a moving recess of the main member.

14. The nut cracker as claimed in claim 13, wherein the nut cracker further comprises a handle, a first handle portion extending downward from the second portion of the main member and connected to the clamping bar to cooperatively form the handle; the clamping bar can drive the gear cutter move when the handle moves back and forth between a first state and a second state under an action of external force; in the first state, a distance between the first handle portion and the clamping bar is minimum and the clamping bar is meshed with the gear cutter, while in the second state, a distance between the first handle portion and the clamping bar is maximum and the clamping bar is meshed with the stopping switch.

15. The nut cracker as claimed in claim 14, wherein in the first state, the gear cutter is separated from the stopping switch, the first elastic element is compressed and the moving post is positioned on a second end of the moving recess, while in the second state, the first elastic element is in an original state, the moving post is positioned on a first end of the moving recess, and the gear cutter is meshed with the stopping switch.

16. The nut cracker as claimed in claim 14, wherein the nut cracker further comprises a receiving room surrounded by the main member and the gear cutter member for receiving a nut therein, and a volume of the receiving room can be changed to open a shell of the nut when the handle moves back and forth between the first state and the second state.

17. The nut cracker as claimed in claim 11, wherein the gear cutter member further comprises a gear cutter shaft fixed to the first portion of the main member and a gear cutter spring sleeved on the gear cutter shaft for resetting the gear cutter.

18. The nut cracker as claimed in claim 11, wherein the clamping member further comprises a clamping shaft connected to the second portion of the main member for rotatably installing the clamping bar with the second portion, and a clamping spring sleeved on the clamping shaft for resetting the clamping bar and driving the clamping bar mesh with or separate from the gear cutter.

19. The nut cracker as claimed in claim 18, wherein the main member further comprises a receiving recess for slidably receiving the clamping shaft therein.

20. The nut cracker as claimed in claim 11, wherein the locating structure comprises a fixing member and a receiving member fixed to the first portion of the main member by the fixing member, a radian of the fixing member is same as that of the first portion of the main member and a radian of a contacting part of the receiving member and the fixing member is also same as that of the fixing member.
